(19) United States
(12) Patent Application Publication
(10) Pub. No.: US 2026/0064524 A1
(43) Pub. Date: Mar. 5, 2026

(54) ERROR CONTROL CODE MANAGEMENT

(71) Applicant: Arm Limited, Cambridge (GB)

(72) Inventors: Isidoros Sideris, Cambridge (GB); Konstantinos Boikos, Cambridge (GB); Daren Croxford, Swaffham Prior (GB); Ian Victor Devereux, Sawston (GB)

(73) Assignee: Arm Limited, Cambridge (GB)

(21) Appl. No.: 18/924,006

(22) Filed: Oct. 23, 2024

(30) Foreign Application Priority Data
Aug. 29, 2024 (EP) 24386102.8

(51) Int. Cl. G06F 11/10

(52) U.S. Cl. CPC G06F 11/1004

(57) ABSTRACT

The present disclosure relates to a data processor and a method of operating a data processor that is operable to execute programs to perform data processing operations, and in which plural execution threads may be grouped together into thread groups in which an instruction is executed upon one or more execution threads of a thread group.

### TECHNICAL FIELD

This invention relates to the management of error control codes in data processing systems. More particularly, this invention relates to the management of the generation error control codes associated with data values stored in in a memory within data processing systems executing threads in a plurality of thread groups.

### BACKGROUND OF THE DISCLOSURE

The technology described herein relates generally to the operation of data processing systems that include programmable processing stages, such as a graphics processing system that includes one or more programmable processing stages (e.g. shaders).

It is becoming increasingly common for data processing systems to be used to process data for use in environments such as automotive and medical environments where it is important, e.g. for safety reasons, that the data values are correct and error free.

It is possible to provide memories with error control codes derived from the data values stored within those memories. Examples of error control codes include error correcting codes, parity values and other forms of error detection and correction codes. Error control codes may serve to detect errors or to both detect and correct errors. If the data values stored within the memory are corrupted for some reason, such as a soft error due to a particle strike, hardware errors, and also to improve yield on partially faulty hardware, then the error control codes may be used to detect that corruption and potentially correct that corruption. This increases the reliability of the data processing system, and or increases yield (and therefore reduces cost).

However, maintaining an error control code incurs a cost, for example, in terms of memory space, power usage, performance, and so on.

The Applicants believe that there remains scope for improvements to the management of error control codes in data processing systems.

### SUMMARY OF THE DISCLOSURE

According to a first aspect of the present disclosure there is provided a method of operating a data processor operable to execute programs to perform data processing operations, and in which plural execution threads may be grouped together into thread groups in which an instruction is executed upon one or more execution threads of a thread group, the method comprising: dividing each execution thread into at least two sub-thread data width groups; during a write access operation to update data values associated with a group of execution threads in a register file based on the execution of the instruction, the method further comprises: calculating a first error control code for a combination of the data values associated with each execution thread in the group of execution threads of a first sub-thread data width group; calculating a second error control code for a combination of the data values associated with each execution thread in the group of execution threads of a second sub-thread data width group; and writing the updated data values associated with a group of execution threads, the first error control code associated with the first sub-thread data width group, and the second error control code associated with the second sub-thread data width group to the register file.

In some embodiments, the method may further comprise: determining, during the write access operation, at least one execution thread in the group of execution threads is inactive; performing a read-modify-write operation to obtain a data value for the at least one inactive execution thread; and wherein calculating the first error control code and the second error control code is based on the data values obtained for the at least one inactive execution thread and the updated data values for at least one active execution thread.

In some embodiments, the at least one inactive execution thread may be inactive due to a divergence between an execution flow of the group of execution threads.

In some embodiments, the method may further comprise: determining, during the write access operation, one or more of the at least one inactive threads in the group of execution threads has been terminated; and suppressing the read-modify-write operation for the one or more terminated inactive threads.

In some embodiments, calculating the first error control code and the second error control code may be based on a default value for the terminated thread. In some embodiments, the default value may be 0.

In some embodiments, a write access operation to data values associated with a group of execution threads may be at a lower granularity than the sub-thread data width group granularity, the method may further comprise: performing a read-modify-write operation to obtain a data value for each execution threads at the required granularity from the register file; and wherein calculating the first error control code and the second error control code may be based on the data values obtained for the required granularity and the updated data values.

In some embodiments, the write access operation may be performed in response to receiving a message request, or an indication, to update one or more data values associated with the group of execution threads in the register file.

In some embodiments, the data processor may further comprise an arithmetic logic unit, wherein the write access operation may be performed in response to the arithmetic logic unit executing the instruction, to perform arithmetic and/or logic operations on the threads of the thread group.

In some embodiments, the data processor may further comprise an operand buffer, wherein the operand buffer may be utilised when performing arithmetic and/or logic operations, the method may further comprise: accessing the register file to read data values associated with one or more execution threads in the group of execution threads into the operand buffer; performing the arithmetic and/or logic operation on the data values to determine updated data values for the one or more execution threads in the group of execution threads; and storing the updated data values in the operand buffer.

In some embodiments, the arithmetic and/or logic operation may be performed on data values from a subset of the group of execution threads, the method may further comprise: setting any execution threads that were not used in the arithmetic and/or logic operation as enabled such that the associated data value is read into the operand buffer.

In some embodiments, dividing each execution thread into at least two sub-thread data width groups may comprise: dividing a width of each execution thread into two equal widths; and wherein the first sub-thread data width group corresponds to a lower half of the two equal widths and the second sub-thread data width group corresponds to an upper half of the two equal widths.

In some embodiments, the first sub-thread data width group may include execution threads from two or more different groups of execution threads, and the second sub-thread data width group may include execution threads from two or more different groups of execution threads.

In some embodiments, the first error control code and second error control code may be calculated according to SECDED ECC (single-error correct and double-error detect error correction code).

According to a second aspect of the present disclosure there is provided a data processor comprising one or more programmable execution units, wherein the data processor is operable to execute programs to perform data processing operations, and in which plural execution threads may be grouped together into thread groups in which an instruction is executed upon one or more execution threads of a thread group, the data processor being further operable to implement a method according to any one of the features of the first aspect of the present disclosure.

It will be appreciated that any features described herein as being suitable for incorporation into one or more aspects or embodiments of the present disclosure are intended to be generalizable across any and all aspects and embodiments of the present disclosure.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF DRAWINGS

Embodiments of the present disclosure will now be described, by way of example only, and with reference to the accompanying drawings, in which:

FIG. 1 shows a conventional error control code arrangement.

FIG. 2 shows a schematic of a graphics processing system, according to one or more embodiments of the present disclosure.

FIGS. 3A and 3B show schematically the issuing of threads for execution, according to one or more embodiments of the present disclosure.

FIG. 4 shows an error control code arrangement according to one or more embodiments of the present disclosure.

FIG. 5 is a flowchart illustrating error control code management according to one or more embodiments of the present disclosure.

FIG. 6 is a flowchart illustrating error control code management according to one or more embodiments of the present disclosure.

FIG. 7 is a flowchart illustrating error control code management according to one or more embodiments of the present disclosure.

FIG. 8 shows a schematic of a graphics processing system, according to one or more embodiments of the present disclosure.

### DETAILED DESCRIPTION

Graphics processing is typically carried out in a pipelined fashion, with one or more pipeline stages operating on the data to generate a final render output, e.g. frame that is displayed and may also be utilised to perform general purpose compute. Many graphics processing pipelines now include one or more programmable processing stages, commonly referred to as “shaders”. For example, a graphics processing pipeline may include one or more of, and typically all of: a geometry shader, a vertex shader, and a fragment (pixel) shader. These shaders are programmable processing stages that execute shader programs on input data values to generate a desired set of output data values, for example appropriately shaded and rendered fragment data in the case of a fragment shader, for processing by the rest of the graphics pipeline and/or for output. The shaders of the graphics processing pipeline may share programmable processing circuitry, or they may each be executed by distinct programmable processing units.

A graphics processing unit (GPU) shader core is thus a processing unit that performs graphics processing by running small programs for each graphics “work” item in a graphics output, such as a render target, e.g. frame, to be generated (an “item” in this regard is usually a vertex or a sampling position (e.g. in the case of a fragment shader)). This generally enables a high degree of parallelism, in that a typical render output, e.g. frame, features a rather large number of vertices and fragments, each of which can be processed independently. Similarly in general purpose compute, each “work” item may be used to compute a portion of the result.

In graphics shader operation, each work “item” will be processed by means of an execution thread which will execute the instructions of the shader program in question for the graphics work “item” in question.

The actual data processing operations that are performed by the shader program will be performed by respective functional units, such as arithmetic units, of the graphics processor, in response to, and under the control of, the instructions in the shader program being executed. Thus, for example, appropriate functional units, such as arithmetic units, will perform data processing operations in response to and as required by instructions in a shader program being executed. Typically, there will be a plurality of functional units provided in a graphics processor (GPU), each of which can be respectively and appropriately activated and used for an execution thread when executing a shader program.

Shader program execution efficiency may be improved by grouping execution threads (where each thread corresponds, e.g., to one vertex or one sampling position) into “groups” or “bundles” of threads, where the threads of one group are run in lockstep, one instruction at a time. In this way, it is possible to share instruction fetch and scheduling resources between all the threads in the group. Other terms used for such thread groups include “warps” and “wave fronts”. For convenience, the term “thread group” will be used herein, but this is intended to encompass all equivalent terms and arrangements, unless otherwise indicated.

In a system where execution threads can be grouped into thread groups, then the functional units for performing the processing operations in response to the instructions in a shader program are normally correspondingly operable so as to facilitate such thread group arrangements. For example, a functional unit may be arranged as respective execution lanes, one for each thread that a thread group may contain (such that, for example, for a system in which execution threads are grouped into groups (warps) of four threads, the functional units may each be operable as four respective (and identical) execution lanes), so that the functional unit can execute the same instruction in parallel for each thread of a thread group.

Each of the threads of a thread group will be associated with a data value (e.g. as input data values to the programmable processing stages and/or as output data values from the programmable processing stages) wherein the data values are stored in a memory, such as a register file, and one or more of the data values of the threads of a group of threads may be accessed in the memory concurrently.

It is becoming increasingly common for data processing systems to be used to process data for use in environments such as automotive and medical environments where it is important, e.g. for safety reasons, that the data values are correct and error free.

It is possible to provide memories with error control codes derived from the data values stored within those memories. Examples of error control codes include error correcting codes, parity values and other forms of error detection and correction codes. Error control codes may serve to detect errors or to both detect and correct errors. If the data values stored within the memory are corrupted for some reason, such as a soft error due to a particle strike, hardware errors, and also to improve yield on partially faulty hardware, then the error control codes may be used to detect that corruption and potentially correct that corruption. This increases the reliability of the data processing system, and or increases yield (and therefore reduces cost).

Each thread is typically associated with a data value that is of a width of a word, however, write operations typically access the data values at lower a granularity than word level, e.g. at byte level or half word level. Maintaining an error control code incurs a cost, for example, in terms of memory space, power usage, performance, and so on. Maintaining an error control code at a lower granularity, e.g. at byte level, may provide the greatest protection but will incur a significant cost (area overhead) as for each byte (8 bits) a 5 bit error control code will need to be maintained and managed. Thus, it is more efficient in terms of the cost incurred to maintain an error control code at a higher granularity, e.g. at the half word level (e.g. 16-bit) or the word level (e.g. 32-bit), but the savings in terms of cost may be offset by the fact that data value accesses can be at byte or half-word level meaning there will be significant time and power costs incurred to maintain and manage an error control code at a higher granularity. (As a byte or half-word write to a word will require a read-modify-write operation, so that the error correction codes are updated correctly).

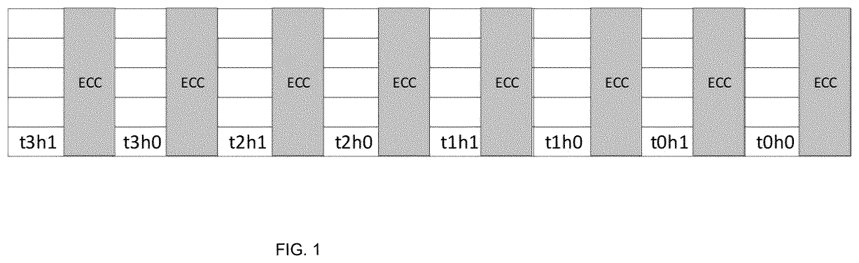

An example is shown with reference to FIG. 1. In FIG. 1, there is shown a thread group comprising four threads, t3, t2, t1, and t0, each with an associated data value of a word (e.g. 32 bits). In this example, an error control code is generated and maintained for each half-word (e.g. 16 bits), h1 and h0, meaning that with four threads in the thread group, eight error control codes are calculated and maintained, which again incurs significant costs and overheads. Furthermore, if the data values of the threads are accessed at byte level (e.g. 8 bits) then additional costs are incurred in performing a read-modify-write operation to correctly update the associated error control code of the associated thread half-word.

The Applicants further believe that there remains scope for improvements to the management of error control codes for a group of threads.

A number of embodiments of the technology described herein will now be described in the context of a data processing system for the processing of computer graphics for display. However, it will be appreciated that the techniques for error control code management for groups of execution threads described herein can be used in other non-graphics contexts in which error control codes for groups of threads are used.

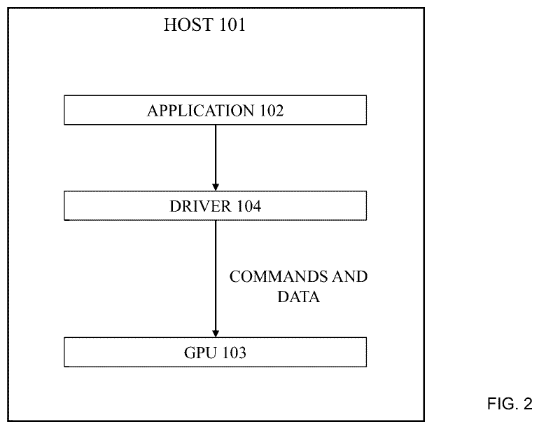

FIG. 2 shows a typical (graphics) data processing system, which includes an application 102, such as a game, executing on a host processor 101 and requires graphics processing operations to be performed by an associated graphics processing unit (graphics processing pipeline) 103. To do this, the application will generate API (Application Programming Interface) calls that are interpreted by a driver 104 for the graphics processor pipeline 103 that is running on the host processor 101 to generate appropriate commands to the graphics processor 103 to generate graphics output required by the application 102. To facilitate this, a set of “commands” will be provided to the graphics processor 103 in response to commands from the application 102 running on the host system 101 for graphics output (e.g. to generate a frame to be displayed, or other processing output).

In embodiments, the graphics processing pipeline 103 is a tile-based renderer and will thus produce tiles of a render output data array, such as an output frame to be generated. In tile-based rendering, rather than the entire render output, e.g., frame, effectively being processed in one go as in immediate mode rendering, the render output, e.g., frame to be displayed, is divided into a plurality of smaller sub-regions, usually referred to as “tiles”.

Each tile (sub-region) is rendered separately (typically one-after-another), and the rendered tiles (sub-regions) are then recombined to provide the complete render output, e.g., frame for display. In such arrangements, the render output is typically divided into regularly-sized and shaped sub-regions (tiles) (which are usually, e.g., squares or rectangles), but this is not essential.

The render output data array may typically be an output frame intended for display on a display device, such as a screen or printer, but may also, for example, comprise intermediate data intended for use in later rendering passes (also known as a “render to texture” output), etc.

When a computer graphics image is to be displayed, it is usually first defined as a series of primitives (polygons), which primitives are then divided (rasterised) into graphics fragments for graphics rendering in turn. During a normal graphics rendering operation, the renderer will modify the (e.g.) colour (red, green and blue, RGB) and transparency (alpha, a) data associated with each fragment so that the fragments can be displayed correctly. Once the fragments have fully traversed the renderer, then their associated data values are stored in memory, ready for output, e.g. for display.

Other arrangements for the graphics processing pipeline 103 would, of course, be possible.

The graphics processing pipeline 103 typically includes a number of programmable processing or “shader” stages, for example, a vertex shader, a hull shader, a domain shader, a geometry shader, and a fragment shader (not shown in FIG. 2). These programmable shader stages execute respective shader programs that have one or more input data values and generate sets of output data values.

Each shader in the graphics processing pipeline is a processing stage that performs graphics processing by running small programs for each “work” item in a graphics output to be generated (an “item” in this regard is usually a vertex, or a fragment). For each work item to be processed, an execution thread that will execute the corresponding shader program is issued to appropriate programmable processing circuitry that then executes the shader program for the execution thread in question.

The present embodiments relate to systems where threads that are to execute a shader program can be organised into groups (“warps”) of threads that are to be run in lockstep, one instruction at a time, which may be referred to as a single instruction, multiple thread (SIMT) arrangement.

In the case of the fragment shader, for example, the fragment shading program that is being executed may be run once for each sampling position (or point) that is to be processed, with one execution thread being spawned for each sampling position. The sampling positions (and thus accordingly their corresponding execution threads) may be organised into and processed as groups of plural sampling positions (and thus threads), each corresponding to the sampling positions associated with a graphics fragment. In the present embodiments, the sampling positions are organised into 2×2 “quads”, and are correspondingly processed in the fragment shader as thread groups (“warps”) containing four threads, each corresponding to one of the sampling positions of the “quad”. The group of threads representing a given sampling position quad then execute the fragment shader program in lockstep, one instruction at a time. Typically, the four threads in a quad, in a graphics fragment processing operation, are adjacent to each other in a 2×2 arrangement, although other arrangements are of course possible, and the distance of the fragments are from each other are used to determine the Level of Detail for texture mapping operation.

In such arrangements, in order to execute the execution threads of a thread group, e.g., so as to perform a fragment shading operation, the execution threads will be appropriately issued to appropriate functional units, such as arithmetic processing units, to perform the processing operations required by the shader program in question. In the case where threads can be organised into and executed as respective thread groups of plural threads, then typically the functional units will be arranged as plural execution lanes, one for each thread of a thread group.

As such, each functional unit (or set of associated functional units) will be arranged and operable as a plurality of execution lanes, to which respective threads of a thread group can be issued for execution. When a thread group is to be executed, appropriate control logic will issue the relevant data and instruction to be executed to the appropriate execution lanes of a functional unit, so that the instruction in question can be executed for the threads of the thread group by the functional unit in parallel.

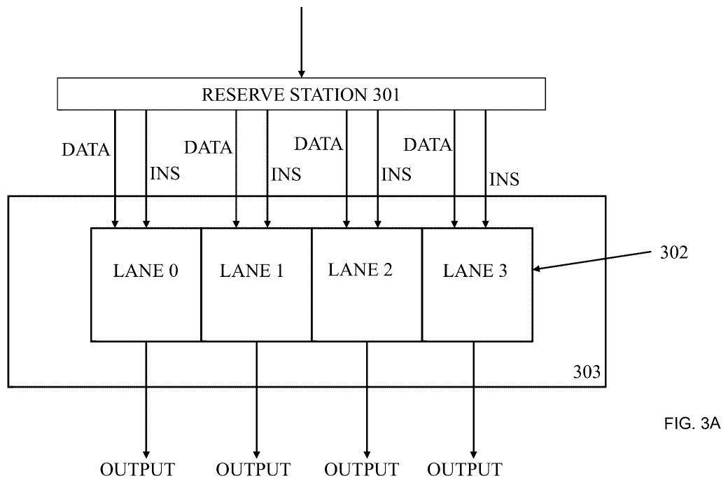

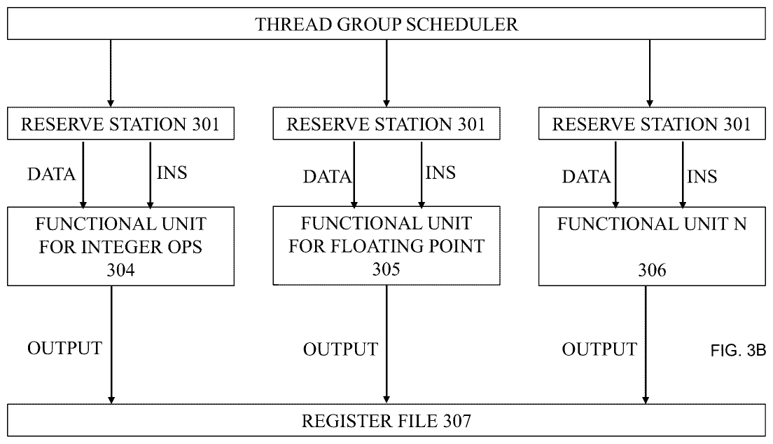

FIGS. 3A and 3B illustrate this.

FIG. 3A shows a functional unit 303 arranged as a set of four execution lanes 302 (so as to correspond to thread groups having four threads (other arrangements would, of course, be possible)), and appropriate control logic in the form of a “reserve station” 301 for issuing the appropriate data and an instruction for each thread of a thread group to a respective execution lane of the set of execution lanes 302 of the functional unit 303. (The reserve station (control logic) 301 will receive threads for execution, e.g., from a thread spawner or a thread spawning process of the graphics processor.)

Where the graphics processor includes plural different functional units that may each execute execution threads to perform processing operations, then each of the functional units may be, and is in an embodiment, arranged as shown in FIG. 3A, i.e. to include a set of plural execution lanes and a corresponding reserve station (control logic) for issuing threads for execution to the execution lanes of the functional unit.

FIG. 3B illustrates this, and shows respective different functional units 304, 305, 306 (each of which will be arranged to contain plural execution lanes as shown in FIG. 3A) each having their own respective reserve station control logic 301 that is operable to issue threads and thread groups for execution to the respective functional unit, with the functional units correspondingly providing their outputs (data values), via a write access operation, e.g. to a register file 307. The register file may be any suitable memory unit, for example, random access memory (RAM), and in particular static RAM (SRAM), which is dimensioned and sized appropriately to store the required data values and associated error control codes. However, other arrangements and implementations of the register file and memory unit are of course possible.

The functional units may comprise, for example, one or more or all of: arithmetic units (arithmetic logic units) (add, subtract, multiply, divide, etc.), bit manipulation units (invert, swap, shift, etc.), logic operation units (AND, OR, NAND, NOR, NOT, XOR, etc.), load-type units (such as varying, texturing or load units in the case of a graphics processor), store-type units (such as blend or store units), etc.

The functional units will perform operations on the data values associated with each thread in the thread group (substantially) simultaneously and write, during a write access operation, the resulting data values to a register associated with the group of threads in a register file.

In order to maintain an error control code with improved cost (e.g. in terms of memory area, time, power requirements, and so on) the threads (and associated data values) are divided, or sub-divided, into a at least two sub-thread data width groups, which, in embodiments, the execution threads are divided into two equal widths wherein a first sub-thread data width group corresponds to a lower half of the two equal widths and a second sub-thread data width group corresponds to an upper half of the two equal widths. For example, each thread and the associated data values of each thread may be of a width of a word (e.g., 32 bits) and each thread is sub-divided into two equal widths of a half-word (e.g., 16 bits), wherein the lower half-word of each thread is grouped together as a first sub-thread data width group and the upper half-word of each thread is grouped together as a second sub-thread data width group. Other divisions of the execution threads and associated data values into sub-thread data width groups of threads is of course possible.

During the write access operation to update the data values (resulting from the execution of the threads) in the associated register of the register file for the sub-thread data width groups by a functional unit, a first error control code is calculated, or generated, for a combination of the data values associated with each execution thread in the group of execution threads of the first sub-thread data width group in the register file. A second error control code is calculated, or generated, for a combination of the data values associated with each execution thread in the group of execution threads of the second sub-thread data width group in the register file.

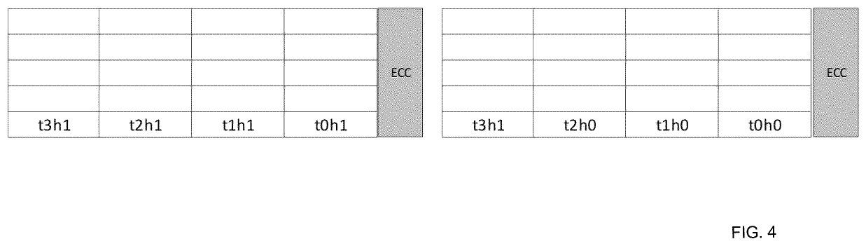

An example is shown in FIG. 4. In FIG. 4, there is shown a thread group comprising four threads, t3, t2, t1, and t0, each with an associated data value of a word in width. In this example, each thread is divided into a first sub-thread data width group (t3h1, t2h1, t1h1, and t0h1) and a second sub-thread data width group (t3h0, t2h0, t1h0, and t0h0), wherein the division is based on a half-word width. A first error control code is generated and maintained for the combination of data values for the first sub-thread data width group and a second error control code is generated and maintained for the second sub-thread data width group Thus, in the example of FIG. 4 only two error control codes are generated and maintained for the four threads of the thread group which is a significant cost saving compared to the example shown in FIG. 1. In terms of an overhead, for a 64 bit combination of data an error control code of 8 bits is required which is significantly less than that required by the example shown in FIG. 1.

The first and second error control codes are then written to the register file. As shown in FIG. 4, the register file may be arranged logically, in that the sub-thread data width group and associated error control code are stored together in the register file (e.g. RAM). However, other arrangements are possible. For example, in order to prevent clustering errors, the data values of the individual threads of one or more of the sub-thread data width groups may be distributed throughout, or within, the register file (e.g. RAM), or individual bytes of the individual threads of one or more of the sub-thread data width groups may be distributed throughout, or within, the register file (e.g. RAM). Additionally, or alternatively, the storage of the error control code associated with the sub-thread data width groups may also be distributed across the register file.

Typically, all of the execution threads of the thread group (e.g. a quad) will be active and exist as in most cases they will not diverge and as such, the data values for each thread during a write access operation will be available for calculating the respective error control code for each of the sub-thread data width groups.

However, at least one execution thread of the group of threads, or a corresponding lane in a functional unit performing processing operations, may be inactive, for example, pending in the data processing system due to divergence, where the thread, or lane, is not inactive for the entire execution of the thread group but is inactive for the current instruction that is being executed for the remaining threads of the thread group. If there is divergence of one or more threads from the other threads in the group of threads, such that the diverging thread will be executed during a later processing cycle, the diverging thread may be indicated, for example, using a mask, that it is inactive at the current execution instruction for the threads of the thread group. In this case, the current data value for the inactive thread(s), or lanes, can be read from memory (e.g. the register file) and combined with the new, or updated, data values resulting from the execution of the active threads, or lanes, to generate the respective error control code for each of the sub-thread data width groups. This may be performed by a read-modify-write operation, in which data values for inactive threads are read from the register file to be combined with the data values for the active threads, for example in a write buffer, and the respective error control code for each of the sub-thread data width groups can be calculated based on the data values in the write buffer. This read-modify-write operation incurs a performance penalty compared with the write access operation alone as the existing data in the register file for the inactive thread(s), or lane(s), needs to be read and loaded into the write buffer in order to calculate the error control code for the sub-thread data width groups. However, the inventors recognised that where the threads belong to the same thread group, there is typically little, or very occasional, divergence between threads of a group of threads. Consequently, the occasional instances where the read-modify-write operation may need to be performed are outweighed by the area savings provided by being able to apply an error control code across the entire sub-thread data width groups.

If at least one execution thread of the group of threads, or a corresponding lane in a functional unit performing processing operations, are inactive due to being, for example, previously terminated, or killed, then during the write access operation a read-modify-write operation may be suppressed as there may be no data value, or the data value is irrelevant, for the terminated execution thread, or lane, and, in this case, there is no benefit for incurring the performance penalty related to performing a read-modify-write operation. Instead, the data value for the inactive execution thread that has been terminated may be set to a default value (e.g. 0) in the write buffer, and the respective error control code for each of the sub-thread data width groups can be calculated, or generated, based on the new, or updated, data values resulting from the execution of the active threads, or lanes, in combination with a data value(s) for the inactive execution threads, or lanes, and the default data value for the inactive terminated execution threads, or lanes.

The determination of whether a thread is inactive and/or terminated, may be based on a thread, or lane, mask, wherein the mask indicates whether a thread, or lane, is active and/or terminated. Other methods of indicating whether a thread, or lane, is active and/or exists are possible.

If the write access operation is at a lower granularity than that of the sub-thread data width groups, for example, at a byte (e.g. 8 bits) level, then a read-modify-write operation can be performed in order to update the respective error control code for each of the sub-thread data width groups to correctly maintain the respective error control code. For example, data values that are not included in the write access operation are read from the register file and loaded into the write buffer alongside the data values at the lower granularity. The respective error control code for each of the sub-thread data width groups can then be calculated, or generated, based on the data values stored in the write buffer.

In some examples, the instruction(s) associated with each thread of the thread group may be processed, or executed, by the current graphics processing pipeline (e.g. by a functional unit of the current processing pipeline) which, on performing the instruction(s), obtains the resulting data value output for each thread, and performs the write access operation to write the resulting data values for each thread to the register associated with the thread group in the register file, and to calculate the error control codes associated with each sub-thread data width group.

In other examples, the instruction(s) associated with each thread of the thread group may be processed, or executed, by a further graphics processing pipeline (e.g. by a functional unit of the further processing pipeline), that is different, or external to, to the current graphics processing pipeline handling the thread group. In this example, a message is transmitted, or an indication provided, to the further graphics processing pipeline to perform, or execute, the instruction(s) associated with the threads of the thread group. Once the further graphics processing pipeline has performed, or executed, the instruction(s), and obtains the resulting data value output for each thread, the further graphics processing pipeline transmits, or provides an indication, to the current graphics processing pipeline with the obtained resulting data values, such that the write access operation can be performed by the current processing pipeline to write the resulting data values for each thread to the register associated with the thread group in the register file, and update the error control codes associated with each sub-thread data width group. Accordingly, the write access operation can be performed in response to receiving a message request, or an indication, from an external processing pipeline (or a functional unit of the external processing pipeline). Other arrangements would of course be possible.

In further examples, the instruction(s) associated with each thread of the thread group may be processed, or executed, by an Arithmetic Logic Unit (ALU). The data values for the threads will be read, or loaded, into an operand buffer and the ALU performs the arithmetic or logic operation (e.g. a floating-point operation) on the data values in the operand buffer. The operand buffer is then updated with the resulting data values of the ALU operation and a write access operation (e.g. a writeback operation) is performed wherein the respective error control codes for each sub-thread data width group are calculated.

If a thread, or lane, is inactive for the ALU operation, the data value for the inactive thread, or lane, may be read into the operand buffer such that the data value is present for when the resulting data values for the active threads, or lanes, are written back to the register in the register file enabling the respective error control code for each sub-thread data width group to be calculated. Thus, the inactive threads, or lanes, may be set or indicated as enabled such that the data values of the inactive threads, or lanes, are read into the operand buffer.

As shown in FIG. 4, the two sub-thread data width groups are shown as logically ordered, that is with consecutive threads (t3, t2, t1, t0) and each sub-thread data width groups corresponding to the low half-words and the high half-words respectively of the consecutive threads. However, in embodiments, the threads will not be stored in the register file consecutively such that the sub-thread data width groups will each include threads from different thread groups, in other words, the threads from different thread groups may be interleaved in the sub-thread data width groups. Thus, each sub-thread data width group may include threads from two or more different groups of threads.

Each group of threads may correspond to a quad, or each group of threads may correspond to multiple quads. In the case that each group of threads correspond to multiple quads then each group of threads may be further divided, or sub-divided, into sub-thread groups where each sub-thread group corresponds to a quad of the multiple quads. The process and arrangement described hereinabove in relation to a group of threads would equally apply to the sub-thread groups.

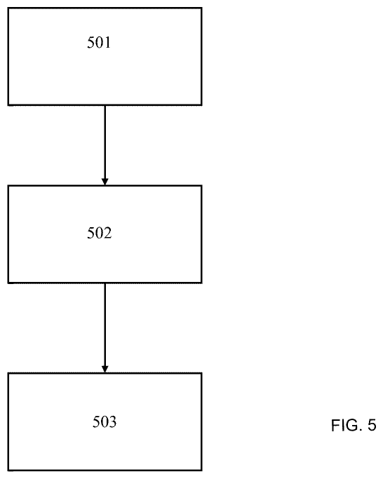

FIG. 5 shows a flowchart of a process according to one or more embodiments in which all threads of a thread group are active and exist. In step 501 a message request for a write access operation is received. The message request will include the updated data values (obtained as a result of a processing operation on the threads of thread group) for the write operation to the register file. In step 502 the data values for each thread are written to a write buffer and the respective error control codes for the sub-thread data width groups are calculated. In step 503 the data values and respective error control codes are written to the associated register(s) in the register file.

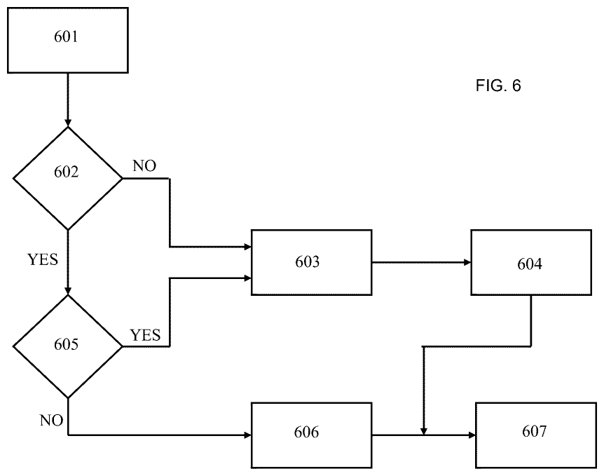

FIG. 6 shows a flowchart of a process according to one or more embodiments in which one or more threads of a thread group (e.g. a quad) may be inactive and where the write access may be at a lower granularity to the sub-thread data width group. In step 601 a message request for a write access operation is received. The message request will include the updated data values (obtained as a result of a processing operation on the threads of thread group) for the write operation to the register file. In step 602 it is determined whether all threads of the group of threads are active. If the determination at step 602 is negative, e.g. at least one thread is inactive, for example, due to a divergence, then a read-modify-write operation is performed in steps 603 and 604 to obtain data value(s) for the inactive threads.

In step 603 the register file write buffer is updated with any missing data values for the threads from the associated register in the register file, and in in step 604 the register file write buffer is updated with the data values included in the message request for a write access operation, such that the write buffer includes data values for all threads of the thread group, and the respective error control codes for the sub-thread data width groups are calculated, or generated. Once the read-modify-write operation has been completed the process moves to step 607.

If the determination in step 602 is positive, then in step 605 it is determined if the data values included in the message request for a write access operation includes data values at a lower granularity than the sub-thread data width group. If the determination at step 605 is positive, then a read-modify-write operation is performed in steps 603 and 604 (as described above).

If the determination in step 605 is negative, then in step 606 the data values for each thread included in the message request for a write access operation are written to a write buffer and the respective error control codes for the sub-thread data width groups are calculated.

Finally, in step 607 the data values and respective error control codes are written to the associated register(s) in the register file.

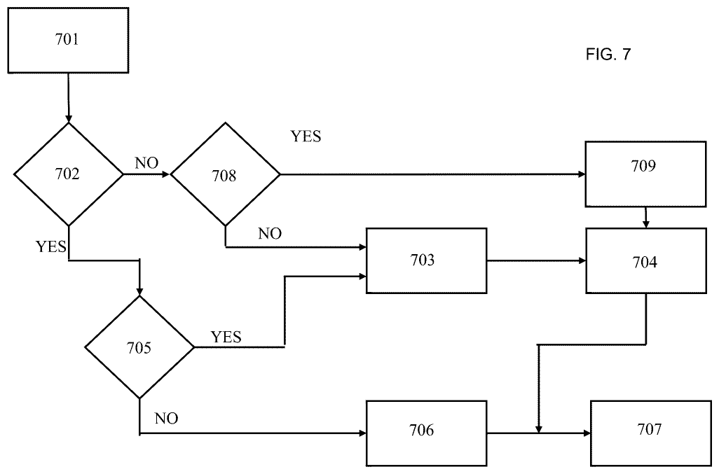

FIG. 7 shows a flowchart of a process according to one or more embodiments in which one or more threads of a thread group (e.g. a quad) may be inactive, an inactive thread may have been terminated, and where the write access may be at a lower granularity to the sub-thread data width group. In step 701 a message request for a write access operation is received. The message request will include the updated data values (obtained as a result of a processing operation on the threads of thread group) for the write operation to the register file. In step 702 it is determined whether all threads of the group of threads are active. If the determination at step 702 is negative, e.g. at least one thread is inactive, then a further determination is performed in step 708 to determine if any of the inactive threads have been terminated. If the determination is positive then a read-modify-write operation is suppressed and a default data value used for any inactive and terminated execution threads in step 709, wherein the register file write buffer is updated with the default data value. If one or more inactive execution threads have not been terminated then a read-modify-write operation is performed in steps 703 and 704 to obtain the data value(s) for the inactive, but not terminated, execution threads.

In step 703 the register file write buffer is updated with any missing data values for the execution threads from the associated register in the register file, and in in step 704 the register file write buffer is updated with the data values included in the message request for a write access operation, such that the write buffer includes data values for all threads of the thread group, and the respective error control codes for the sub-thread data width groups are calculated, or generated. Once the read-modify-write operation has been completed the process moves to step 707.

If the determination in step 702 is positive, then the process proceeds to step 705 in which it is determined if the data values included in the message request for a write access operation includes data values at a lower granularity than the sub-thread data width group. If the determination at step 705 is positive then a read-modify-write operation is performed in steps 703 and 704 (as described above).

If the determination in step 705 is negative, then in step 706 the data values for each thread included in the message request for a write access operation are written to a write buffer and the respective error control codes for the sub-thread data width groups are calculated.

Finally, in step 707 the data values and respective error control codes are written to the associated register(s) in the register file.

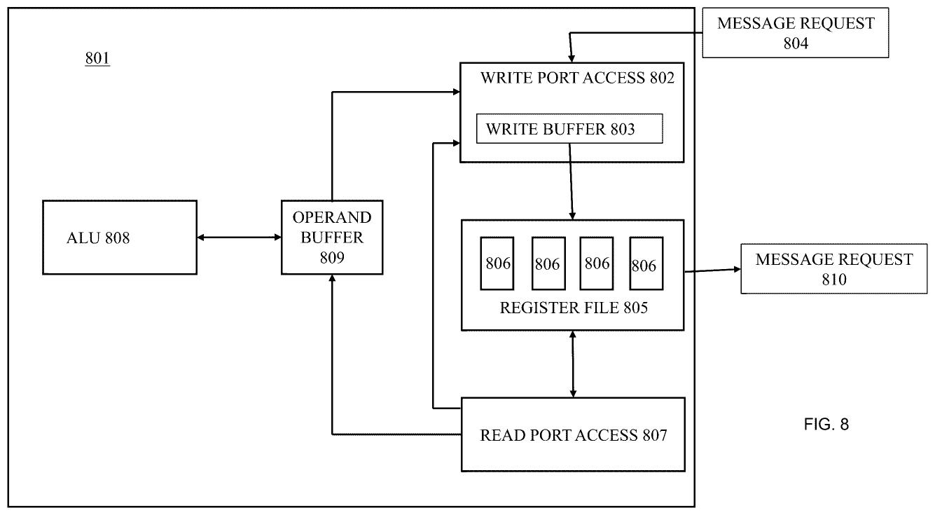

FIG. 8 is a schematic of an arrangement and data path according to embodiments of the present disclosure. As will be appreciated, other arrangements and data paths will be possible, and the data processing system may include any number of further units as required for the data processing system.

The data processing system 801 includes a write port access 802, which includes a write buffer 803. Message requests 804 for a write access operation may be received by the write port access 802, for example, from a functional unit. The write port access 802 is in communication with a register file 805 which includes a number of registers 806 for storing data values associated with a plurality of threads. A received message request 804 for a write access operation includes the “new” data values for each thread of a thread group, wherein each thread is sub-divided into at least two sub-thread data width groups. The data values are written to the write buffer 803 and a respective error control code is calculated for each of the sub-thread data width groups. The data values and associated error control codes are then written to the associated registers 806 in the register file 805.

If any data values for one or more threads of the group of threads are not included in the message request 804 (e.g. due to being inactive, terminated, and so on), then a read port access 807 may read the relevant data values from the associated register(s) 806 in the register file 805, or obtain a default data value, and load those relevant data values into the write buffer to enable the respective error control code to be calculated for each of the sub-thread data width groups.

If a processing operation is to be performed by a functional unit then a message request 810 may be transmitted to the functional unit including the relevant data values associated with the threads of the thread group on which the functional unit may perform a processing operation.

A write access operation may also be triggered by processing operations performed by the ALU 808, instead of by a message request 804. An ALU 808 performs any arithmetic or logic operation, for example, floating-point operations, required by the threads of the thread group. When an ALU operation is required, an operand buffer 809 is loaded with the data values for the threads from the register file 805, via the read port access 807. The ALU 808 performs the required arithmetic or logic operation and returns the resulting data values to the operand buffer 809, which in turn requests a write access operation (e.g. a writeback operation) to the write port access 802. The data values for the threads of the thread group stored in the operand buffer 809 are loaded into the write buffer 803 and the respective error control code to be calculated for each of the sub-thread data width groups. The data values and associated error control codes are then written to the associated registers 806 in the register file 805.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A method of operating a data processor operable to execute programs to perform data processing operations, and in which plural execution threads may be grouped together into thread groups in which an instruction is executed upon one or more execution threads of a thread group, the method comprising:
dividing each execution thread into at least two sub-thread data width groups;
during a write access operation to update data values associated with a group of execution threads in a register file based on the execution of the instruction, the method further comprises:
calculating a first error control code for a combination of the data values associated with each execution thread in the group of execution threads of a first sub-thread data width group;
calculating a second error control code for a combination of the data values associated with each execution thread in the group of execution threads of a second sub-thread data width group; and
writing the updated data values associated with a group of execution threads, the first error control code associated with the first sub-thread data width group, and the second error control code associated with the second sub-thread data width group to the register file.

2. The method of claim 1, further comprising:
determining, during the write access operation, at least one execution thread in the group of execution threads is inactive;
performing a read-modify-write operation to obtain a data value for the at least one inactive execution thread; and
wherein calculating the first error control code and the second error control code is based on the data values obtained for the at least one inactive execution thread and the updated data values for at least one active execution thread.

3. The method of claim 2, wherein the at least one inactive execution thread is inactive due to a divergence between an execution flow of the group of execution threads.

4. The method of claim 2, further comprising:
determining, during the write access operation, one or more of the at least one inactive threads in the group of execution threads has been terminated; and
suppressing the read-modify-write operation for the one or more terminated inactive threads.

5. The method of claim 4, wherein calculating the first error control code and the second error control code is based on a default value for the terminated thread.

6. The method of claim 5, in which the default value is 0.

7. The method of claim 1, in which a write access operation to data values associated with a group of execution threads is at a lower granularity than the sub-thread data width group granularity, the method further comprises:
performing a read-modify-write operation to obtain a data value for each execution threads at the required granularity from the register file; and
wherein calculating the first error control code and the second error control code is based on the data values obtained for the required granularity and the updated data values.

8. The method of claim 1, in which the write access operation is performed in response to receiving a message request, or an indication, to update one or more data values associated with the group of execution threads in the register file.

9. The method of claim 1, in which the data processor further comprises an arithmetic logic unit, wherein the write access operation is performed in response to the arithmetic logic unit executing the instruction, to perform arithmetic and/or logic operations on the threads of the thread group.

10. The method of claim 9, in which the data processor further comprises an operand buffer, wherein the operand buffer is utilised when performing arithmetic and/or logic operations, the method further comprising:
accessing the register file to read data values associated with one or more execution threads in the group of execution threads into the operand buffer;
performing the arithmetic and/or logic operation on the data values to determine updated data values for the one or more execution threads in the group of execution threads; and
storing the updated data values in the operand buffer.

11. The method of claim 10, in which the arithmetic and/or logic operation is performed on data values from a subset of the group of execution threads, the method further comprises:
setting any execution threads that were not used in the arithmetic and/or logic operation as enabled such that the associated data value is read into the operand buffer.

12. The method of claim 1, in which dividing each execution thread into at least two sub-thread data width groups comprises:
dividing a width of each execution thread into two equal widths; and
wherein the first sub-thread data width group corresponds to a lower half of the two equal widths and the second sub-thread data width group corresponds to an upper half of the two equal widths.

13. The method of claim 1, in which the first sub-thread data width group includes execution threads from two or more different groups of execution threads, and the second sub-thread data width group includes execution threads from two or more different groups of execution threads.

14. The method of claim 1, in which the first error control code and second error control code are calculated according to SECDED ECC.

15. A data processor, wherein the data processor is operable to execute programs to perform data processing operations, and in which plural execution threads may be grouped together into thread groups in which an instruction is executed upon one or more execution threads of a thread group, the data processor being further operable to implement a method according to claim 1.
